(19) United States
(12) Patent Application Publication
(10) Pub. No.: US 2010/0034240 A1
(43) Pub. Date: Feb. 11, 2010

(54) Transmitter-Receiver System

(75) Inventors: Elwin De Weerdt, Delft (NL); Erik-Jan Van Kampen, Haarlem (NL); Qi-Ping Chu, Delfgauw (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 12/537,551

(22) Filed: Aug. 7, 2009

Related U.S. Application Data
(63) Continuation of application No. PCT/EP2008/067245, filed on Dec. 10, 2008.

(30) Foreign Application Priority Data
Jan. 28, 2008 (EP) EPO 08100981.3

(51) Int. Cl. H04L 5/16

(52) U.S. Cl. 375/219

(57) ABSTRACT

The invention relates to a transmitter-receiver system comprising at least three transmitters and at least a first receiver and a second receiver, wherein the receivers are connected to a computing device that is arranged to analyse signals that said receivers receive from said transmitters and to calculate length and attitude information of an imaginary baseline connecting said receivers depending on at least carrier phase information of said signals using interval analysis.

### CROSS-REFERENCE TO RELATED APPLICATIONS

This application is a continuation application of International Bureau Patent Application Serial No. PCT/EP2008/067245, entitled “Transmitter-receiver system”, to Technische Universiteit Delft, filed on Dec. 10, 2008, and the specification and claims thereof are incorporated herein by reference.

This application is a continuation of European Patent Office Patent Application Serial No. 08100981.3, entitled “Transmitter-receiver system”, to Technische Universiteit Delft, filed on Jan. 28, 2008, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The invention relates to a transmitter-receiver system comprising at least three transmitters and at least a first receiver and a second receiver, wherein the receivers are connected to a computing device that is arranged to analyse signals that said receivers receive from said transmitters and to calculate length and attitude information of an imaginary baseline connecting said receivers depending on at least carrier phase information of said signals.

2. Description of Related Art

Such a transmitter-receiver system is for instance known from US 2005/0043887.

In the known method and system a normalized spectral analysis is performed before intercorrelation of demodulated signals. A phase coherence resetting of the signals is carried out before said recombination and a phase offset measurement is carried out by a true intercorrelation of the homologous satellite path base by interferometry of the two signals arising from one and the same satellite and received respectively by a pair of antennas. Subsequently, a reduction of the initial ambiguity removal search domain is performed for the determination of attitude of a vehicle by interferometric GPS-measurement and implementing a statistical test for the selection of the ambiguity.

In general, in the case of global navigation satellite systems three types of measurements are available: the code-based, carrier frequency and carrier phase measurements.

When applying code-based pseudo-range measurements, only limited accuracy is available, partly due to uncertainty and inaccuracy in the determination of the distances between transmitters and receivers.

When applying carrier phase measurements, higher accuracy is available, but ambiguities in the number of carrier wave cycles introduce uncertainties, which means there is uncertainty in respect of the determined length and attitude information.

US 2007/0075896 teaches a method and system for determining at least one attitude angle of a rigid body. In this method and system global navigation satellite signals are received with a plurality of antennas. Then, at least one pair of antennas is established such that each antenna of the plurality of antennas is included in at least one antenna pair and computing of single- or double-difference phase signals are carried out corresponding to one or more GNSS-satellites for each of the pairs of antennas. Based thereon, a single differential carrier phase attitude (DCPA) equation is construed based on known geometry constraints of each of the pairs of antennas. The solution for the DCPA-equation is based on a cost function, and the solution yields at least one integer ambiguity value and at least one attitude angle. A drawback of this known system and method is that there is no guarantee that the integer ambiguity value is accurately resolved.

### BRIEF SUMMARY OF THE INVENTION

The invention now concerns a transmitter-receiver system in accordance with the preamble with higher accuracy and improved certainty as to the length and attitude of the baseline connecting the receivers as measured by making use of the carrier phase information on the signals received from the transmitters. The invention is also embodied in a method to determine the length and attitude of the baseline connecting the receivers.

The transmitter-receiver system of the invention and the method of its operation is characterized by one or more of the appended claims.

In a first aspect of the invention the transmitter-receiver system is characterized in that for each combination of transmitter i and receiver j the computing device establishes an imaginary interval cone having as an imaginary axis a line of sight between the combination's sender i and receiver j, and a top coinciding with the receiver j of such combination, said cone having a body with an interval-range for the top angle αij of said body defined by said imaginary baseline rotated around the line of sight between the transmitter i and receiver j, wherein the body of the cone represents an interval of integer values added to a phase value of the signal received by the receiver j of said combination, each integer value corresponding to a multiplication factor of the signal's wavelength, said phase value added to the interval of integer values thus corresponding to an interval of possible distances between said transmitter i and receiver j of such combination, and in that the computing device establishes for each two combinations of senders and receivers the respective top angles αij at which the corresponding interval cones intersect, and that upon such intersection the corresponding integer values are used as a measure for the orientation and length of said baseline between the receivers of both combinations.

Preferably in this system the phase value is determined as an interval of values of the signal received by the receiver of said combination. This resolves any corrupted phase value information due to for instance noise, which might otherwise deteriorate the system's performance.

The inventors have established that the transmitter-receiver system of the invention involves accuracy in the millimeter level and that the system of the invention provides a guaranteed measurement of the distances between the concerned receivers. Thus, a highly accurate length and attitude of the baseline connecting the receivers can be calculated.

It is further beneficial that the carrier phase information of the first receiver and the second receiver is modified prior to the formation of said imaginary cones by subtracting in a first subtracting step the carrier phase information from both receivers from each other resulting in a single difference phase signal which is used as the phase signal for the formation of the imaginary interval cones.

This feature of the transmitter-receiver system of the invention provides the advantage that phase bias of the transmitted signals can be eliminated.

In a further advantageous embodiment it is preferable that the single difference phase signal originating from a first transmitter signal received by a first receiver and a second receiver is further modified by subtracting in a second subtracting step therefrom a single difference phase signal originating from a second transmitter signal received by said first receiver and said second receiver, resulting in a double difference phase signal which is used as a phase signal for the formation of the imaginary interval cones.

By thus subtracting the single difference phase measurement signal relating to a first transmitter from the single difference phase measurement signal relating to a second transmitter, the receiver clock error and phase bias of the signal at the receiver end can be eliminated, and the thus obtained double difference phase signal can advantageously be used in the formation of the measurement of the imaginary interval cones.

Further preferential features of the transmitter-receiver system of the invention are that the selection of combinations of integers corresponding to intersecting imaginary interval cones is carried out by eliminating such intervals of integers which do not relate to intersecting interval cones and that the process of eliminating intervals of integers is carried out in steps wherein each step involves partitioning of the remaining ranges, which process is only completed when a single integer solution remains.

### BRIEF DESCRIPTION OF THE SEVERAL VIEWS OF THE DRAWINGS

The invention shall hereinafter be further elucidated with reference to an exemplary embodiment relating to the attitude determination of an aircraft using GPS (Global Positioning System). Further reference is made to the drawing in which:

FIG. 1 shows an aircraft provided with receivers;

FIG. 2 shows schematically so-called line of sight vectors from the receivers to satellites in view;

FIG. 3 provides a definition of the interval phase measurement;

FIG. 4 shows schematically a system in accordance with the invention comprising three transmitters and two receivers;

FIG. 5 concerns a flow chart setting forth the attitude and length calculation pertaining to a baseline between receivers;

FIG. 6 shows a geometric interpretation of the integer ambiguity problem;

FIG. 7 shows a geometry of single difference phase measurements in the presence of short baselines;

FIG. 8 shows possible baseline orientations per satellite and a single intersection point for all satellites, and

FIG. 9 shows initial baseline orientation possibilities for short and long baselines.

### DETAILED DESCRIPTION OF THE INVENTION

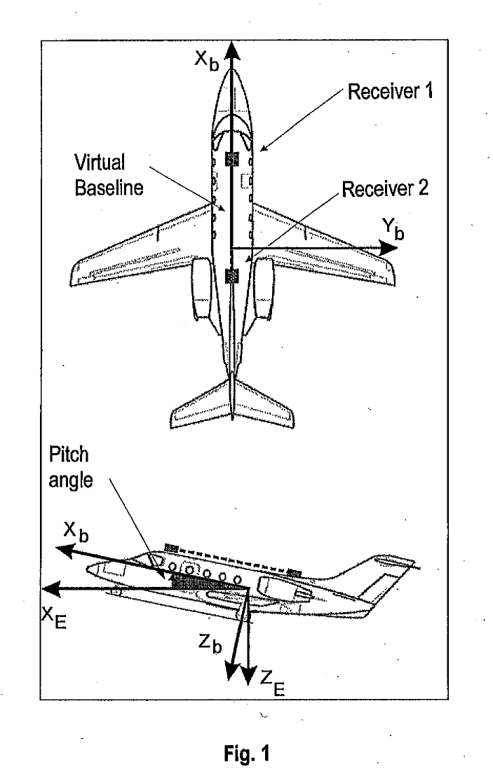

With reference to FIG. 1 it is shown that a first receiver 1 and a second receiver 2 are placed along the axis of the aeroplane of which the attitude needs to be determined.

The lower part of FIG. 1 shows as an example that the receivers 1 and 2 are placed on the fuselage which makes it possible to determine the pitch angle of the airplane. The virtual baseline between receivers 1 and 2 has a fixed length. In view of the fact that the orientation of the earth axis with respect to the GPS frame can be determined for any location on earth, it suffices to know the orientation of the virtual baseline between said receivers 1, 2 in the GPS-frame, and the orientation of the virtual baseline between said receivers 1, 2 in the body frame, which is determined by the positioning of the receivers on the aeroplane body, to determine the pitch angle of the aeroplane.

The problem of establishing the pitch angle is solved following the procedure below.

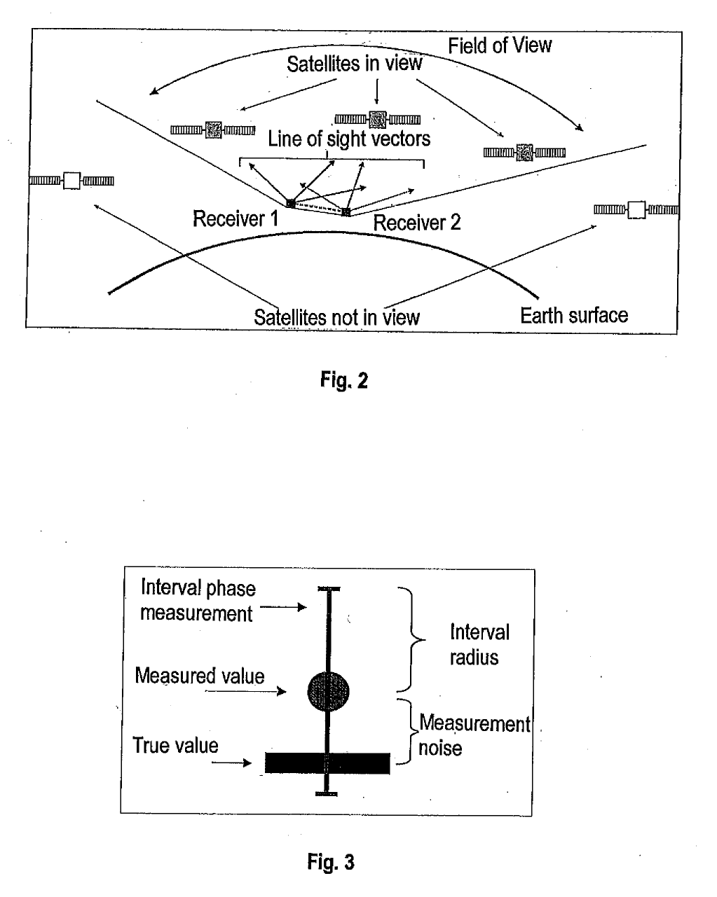

Data is transmitted from the GPS satellites and is received by the GPS receivers 1, 2 (see FIG. 2).

From the data received by the GPS receivers 1, 2 it is possible to determine the approximate position of both GPS receivers (+/−20 meters) and the approximate position of the GPS satellites in view (+/−5 meters). The phase of the carrier wave from each satellite in view is measured by the receivers 1, 2 (there can be multiple frequencies).

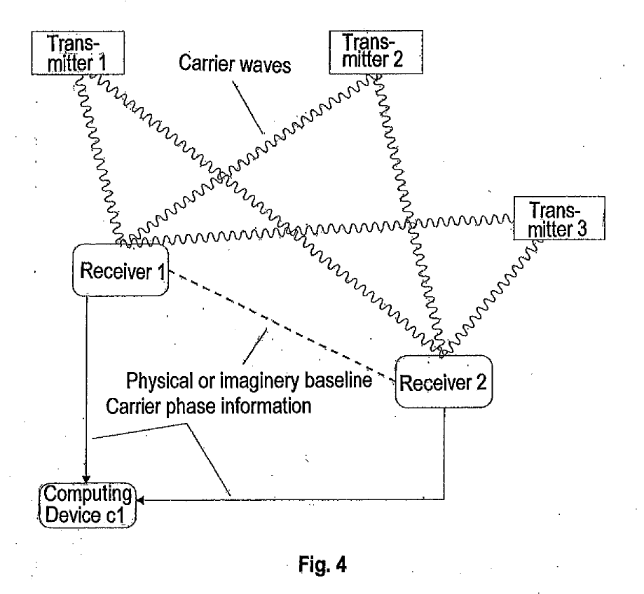

The approximate positions and the phase measurements are passed from the receivers 1, 2 to a computing device c1 (see FIG. 4). In the shown case of an aircraft the computing device c1 is connected to the receivers via cables. In other applications the data can also be transmitted via a wireless connection from the receivers to the computing device. The measurements are preferably taken at the same time by both receivers 1, 2. The maximum allowed timing error between the signals at the receivers 1, 2 depends on the system dynamics. For any system holds that the larger the timing error the less accurate the final result will be. Taking the measurements at the same time can be realized by setting the internal clocks of each receiver 1, 2 exactly equal at some point in time, and scheduling the measurements per receiver 1, 2 based on its internal clock. By tagging the measurements with a time label the computing device c1 can match the measurements from each receiver 1, 2 even when they are received at different points in time (the location of the computing device c1 does not have to be fixed with respect to the receivers 1, 2).

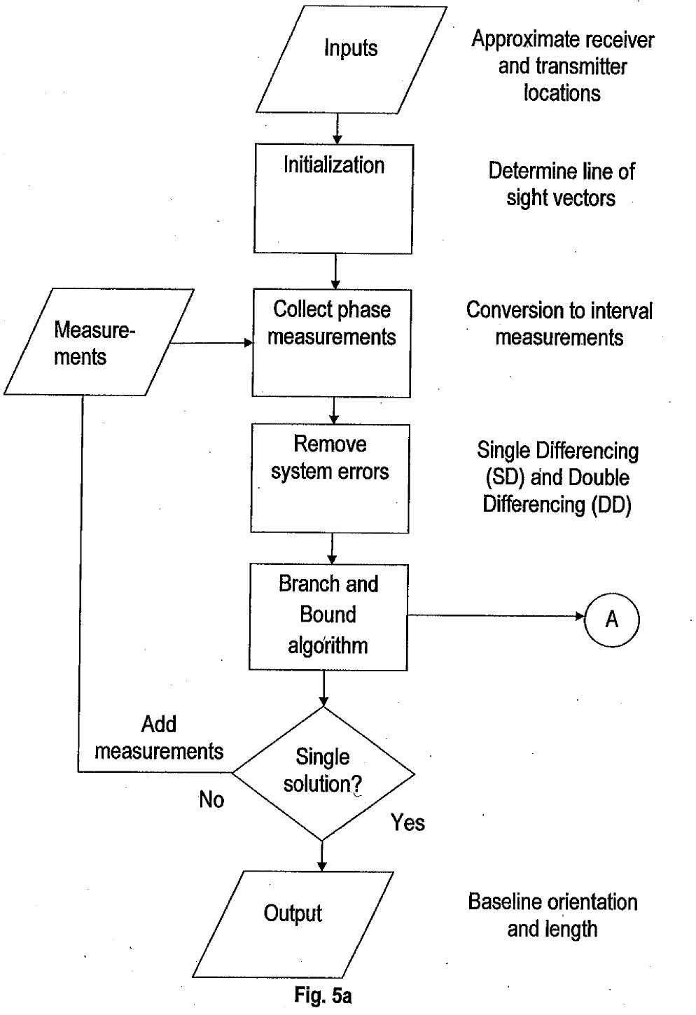

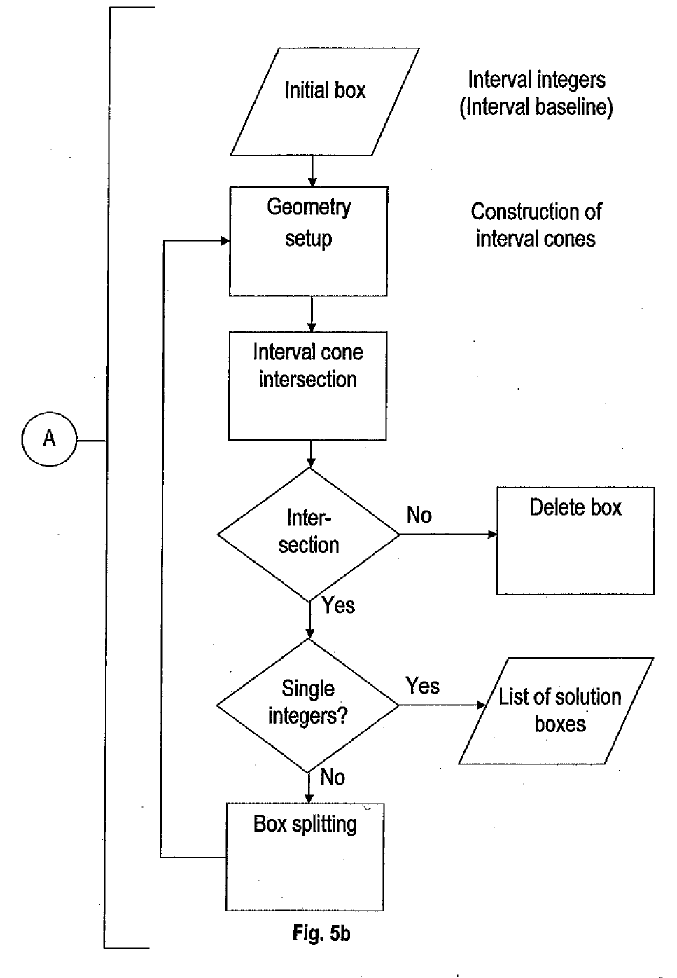

The following steps are then performed by the computing device c1 (see flowchart in FIG. 5)

From the approximate positions of the receivers 1, 2 and transmitters (satellites) the line of sight vectors are determined (see FIG. 2). It is preferred that the uncertainty in the position of transmitters and receivers is several magnitudes less than the actual distance between the transmitters and receivers. If this condition is fulfilled than the line of sight vectors can be accurately determined. For GPS this condition is certainly fulfilled. Any remaining uncertainties on the line of sight vectors can be propagated into uncertainties on the found orientation of the baseline.

By double differencing the phase measurements as discussed hereinabove most system errors (atmospheric effects, time delays, etc.) are eliminated yet measurement noise on the data remains. To be sure that the correct phase value is taken into account, the computing device c1 establishes a so-called ‘interval phase measurement’. The computing device c1 then establishes, for a predetermined selection of possible combinations of integers, when the bodies of the imaginary interval cones intersect. Said integers that result from the calculation are used as an accurate measure for the orientation and length of the baseline between the receivers.

When a single integer solution remains, this solution is guaranteed to be the sought for solution.

Interval phase measurements as mentioned in the previous paragraph, are defined as intervals containing all phase values between the upper and lower bounds of an interval. The upper bound is formed by taking the measured phase values and adding an interval radius, see FIG. 3. The lower bound is formed by taking the measured phase values and subtracting the same interval radius. The key aspect is that if the interval radius is set larger than the measurement noise and other system uncertainties, the true (uncorrupted) phase value lies within the interval phase measurement, and it is guaranteed to obtain the correct integer representing the intersection of the imaginary cones, and which represents a measure for the length and attitude of the baseline between the receivers 1, 2.

Subsequently a branch and bound algorithm is applied, which finds the correct integers using the phase measurements and line of sight vectors. This process is represented in the flowchart in FIG. 5.

The description of the algorithm according to FIG. 5 that determines the orientation of the baseline with high accuracy can be itemized as follows.

Inputs:

Approximate receiver 1, 2 locations (e.g. ±20 m for GPS)

Approximate transmitter locations (e.g. ±5 m for GPS).

Initialization:

Determine the line of sight vectors from the receivers 1, 2 to all transmitters in view. The assumption is made that the uncertainty in receiver location and transmitter location is much smaller than the distance between the receivers and the transmitters, which means the error in determining the line of sight vectors can be neglected. (Certainly valid for GPS: ±20 m vs. >20.000.000 m)

Collecting of Measurements:

Collect the phase measurements from both receivers 1, 2 for all visible satellites and for all available frequencies at the current epoch.

Convert the phase measurements into interval phase measurements by adding an interval number to each measurement. This interval number is called the noise band and it ensures that the correct phase measurement (i.e. the phase if there is no noise at all) lies inside the phase measurement interval.

Removing System Errors:

For each satellite and all frequencies, compute the difference in interval phase measurements between the two receivers 1, 2. This results in the Single Difference (SD) interval phase measurements. This step removes the transmitter clock errors and common atmospheric disturbances.

Pick one of the available transmitters as a reference and subtract the SD interval phase measurements from all other transmitters from the reference to obtain the Double Difference (DD) interval phase measurements. This step removes the receiver clock errors.

Geometry Setup:

By going from SD to DD, the geometry of the problem has shifted and the line of sight vectors corresponding to the DD-phase data now point to virtual transmitters that are created by subtracting the true transmitter positions from the reference transmitter position.

For each virtual transmitter and each frequency construct an imaginary interval cone. All interval cones have their origin in one of the receivers (always the same one). The cone angle is an interval and is initialized based on all possible integer number of cycles and the current DD interval phase measurements. Points in the volume defined by said imaginary cone of one receiver, and described by the intersection of the interval cone and a spherical shell with inner radius equal to the minimal baseline length and outer radius equal to the maximum baseline length, are the possible locations of the other receiver.

Interval Cone Intersection:

Intersection points of regular cones are found by determining common spherical coordinates of the cones. The intersection points are described by the radius, cone angle and azimuth angle in the reference frame of one of the cones. Correspondingly, intersection volumes of interval cones are found by determining common spherical coordinates of the interval cones. The intersection volumes are described by the interval radius, interval cone angle and interval azimuth angle in the reference frame of one of the cones.

The interval cone intersection volumes, initially computed for the combination of all possible integers, can similarly be computed for any combination of subsets of all possible integers. This procedure will be called the integer to intersection mapping.

Branch and Bound Algorithm:

The task of this algorithm is to identify which combination of integers (one integer per transmitter) will lead to an intersection of the interval cones. The total number of integer combinations can be very large, depending on the length of the baseline and the number of transmitters. The interval branch and bound algorithm is used to efficiently remove intervals of integer combinations for which the integer to intersection mapping gives no intersections (i.e. more than one combination of integers can be removed at once).

The branch and bound algorithm returns a list with integer combinations for which there is an intersection. By the inclusion property of interval analysis it can be proven that the correct integer combination, i.e. the solution obtained if there would be no noise on the phase measurements, is in the list. As soon as only one combination of integers is in the list, this value represents the sought for solution.

When multiple combinations of integers are returned, additional phase measurements are required to eliminate all but one of the combinations. Additional phase measurements can be obtained from additional transmitters, additional frequencies or additional epochs.

Output:

With the correct integer number of cycles found for every transmitter in combination with the collected phase measurements, the cone angle and the length of the projection of the baseline onto the line of sight vectors can be determined with high accuracy. Because the cone angle is equal to the angle between the baseline and the line of sight vector to the transmitter, the orientation of the baseline with respect to the transmitters can thus easily be provided with high accuracy, assuming that there are at least three line of sight vectors available that span a three dimensional space.

A further detailed explanation is provided hereinafter with reference to a particular exemplary embodiment.

### EXAMPLE

In the following discussion the following nomenclature will be applied.
α Cone angle—angle between the baseline vector and the line of sight vector to the satellite
x̅ Correct solution (true value) of variable x
β^{pq} angle between two satellite line of sight vectors
δ Azimuth angle of cone intersection point
δmᵢ^{p} Carrier phase multipath error
εᵢ^{p} Measurement error
λ Carrier wavelength
φ^{p} Phase of satellite generated signal
φ^{p} Carrier phase from satellite p measured by receiver i
φᵢⱼ^{p} Single differenced carrier phase from satellite p measured by receivers i and j (i−j)
φᵢⱼ^{pq} Double differenced carrier phase from satellites p and q (p−q) measured by receivers i and j (i−j)
φᵢ Phase of receiver generated signal
φᵢ^{p} Carrier phase observation multiplied by wavelength
ρᵢ^{p} Geometric distance between satellite antenna and receiver antenna
θ Angle between local and global x-axis
b Baseline vector between receivers
c Nominal speed of light in a vacuum
dt^{p} Satellite clock error
dtᵢ Receiver clock error
e Line of sight vector to satellite
Iᵢ^{p} Ionospheric refraction effect
N Integer ambiguity
Tᵢ^{p} Tropospheric refraction effect

Global navigation satellite systems (GNSS) can be used to determine the position of a receiver on or near the surface of the Earth. For example, in case of GPS two types of measurements are available: the code-based pseudoranges and the carrier-phase measurements. The pseudo random noise (PRN) codes are phase-modulated onto a carrier wave to determine the distance between the receiver and the satellite with mm-level accuracy, but the problem is that a receiver cannot distinguish one carrier wave from the next, resulting in the well-known integer ambiguity problem that the invention now solves.

The phase measurement for receiver rᵢ that is receiving a signal from satellite s^{P} can be written as:

Φᵢ^{p}(t)=ρᵢ^{p}−Iᵢ^{p}+Tᵢ^{p}+δmᵢ^{p}+c[dtᵢ(t)−dt^{p}(t−τᵢ^{p})]+λ[φᵢ(t₀)−φ^{p}(t₀)]+λNᵢ^{p}+εᵢ^{p} 1

where the phase measurement has been multiplied by the carrier wavelength to give an equation in distances. We can eliminate the phase bias of satellite generated signal φ^{p} (t₀) by subtracting from this measurement the measurement from a second receiver, resulting in the single difference (SD) measurement:

Φᵢ^{p}(t)−Φⱼ^{p}(t)=ρᵢ^{p}−ρⱼ^{p}−Iₜ^{p}+Iⱼ^{p}+Tᵢ^{p}−Tⱼ^{p}+δmᵢ^{p}−δmⱼ^{p}+c[dtᵢ(t)−dt^{p}(t−τⱼ^{p})]−c[dtⱼ(t)−dt^{p}(t−τⱼ^{p})]+λ[φᵢ(t₀)−φ^{p}(t₀)]−λ[φⱼ(t₀)−φ^{p}(t₀)]+λNᵢ^{p}−λNⱼ^{p}+εᵢ^{p}−εⱼ^{p} b 2

Assuming that the satellite clock error dt^{p} is constant during receiver clock error time spans, this can be written as:

Φ_{i j}^{p}(t)=ρ_{i j}^{p}−I_{i j}^{p}+T_{i j}^{p}+δm_{i j}^{p}+cdt_{i j}(t)+λφ_{i j}(t₀)+λN_{i j}^{p}+ε_{i j}^{p} 3

By subtracting from this SD measurement the SD measurement from another satellite, the receiver clock error and the phase bias of receiver generated signal φᵢⱼ (t₀) can be eliminated, resulting in the following double difference (DD) measurement equation:

Φ_{i j}^{p}(t)−Φ_{i j}^{q}(t)=ρ_{i j}^{p}−ρ_{i j}^{q}−I_{i j}^{p}+I_{i j}^{q}+T_{i j}^{p}−T_{i j}^{q}+δm_{i j}^{p}−δm_{i j}^{q}+cdt_{i j}(t)−cdt_{i j}(t)+λφ_{i j}(t₀)−λφ_{i j}(t₀)+λN_{i j}^{q}−λN_{i j}^{q}+ε_{i j}^{q}−ε_{i j}^{q} 4

Φ_{i j}^{pq}(t)=ρ_{i j}^{pq}−I_{i j}^{pq}+T_{i j}^{pq}+δm_{i j}^{pq}+λN_{i j}^{pq}+εᵢⱼ^{pq} 5

Multipath errors can be reduced by placing the receivers in locations away from interfering surfaces and by shaping of the receiver antenna. The atmospheric effects can be partly removed by comparing their effect on different frequencies and by using models based on local air pressure and temperature. The double differenced multipath and atmospheric errors are lumped with the measurement error:

\hat{ε}_{i j}^{pq}=−I_{i j}^{pq}+T_{i j}^{pq}+δm_{i j}^{pq}+ε_{i j}^{pq} 6

resulting in the simplified DD equation:

Φ_{i j}^{pq}(t)=ρᵢⱼ^{pq}+λN_{i j}^{pq}+\hat{ε}_{i j}^{pq} 7

II

The problem of integer ambiguity resolution is that given a set of phase measurements for two receivers and four or more satellites, an estimated baseline length, and the line of sight vectors from the receivers to the satellites, it is required to estimate the integers and baseline orientation which fulfill the following relations:

Single difference:

Φ_{i j}^{p}(t)=ρ_{i j}^{p}+λN_{i j}^{p}+\hat{ε}_{i j}^{p}

Double difference:

Φ_{i j}^{pq}(t)=ρ_{i j}^{pq}+λN_{i j}^{pq}+\hat{ε}_{i j}^{pq} 8

This problem can be interpreted geometrically and a non-linear optimization problem with geometric constraints can be set up. The geometric approach is best explained by looking at the single difference case. In practice it is preferred to consider the double difference model (which eliminates any receiver clock errors and common atmospheric errors). In the following discussion the line of sight vectors to the satellites have been determined by pseudorange positioning, where the inaccuracies in angle caused by the pseudorange positioning inaccuracy are negligible (distance to satellite >> position uncertainties, which is certainly the case for GPS applications).

II.A. Single difference model

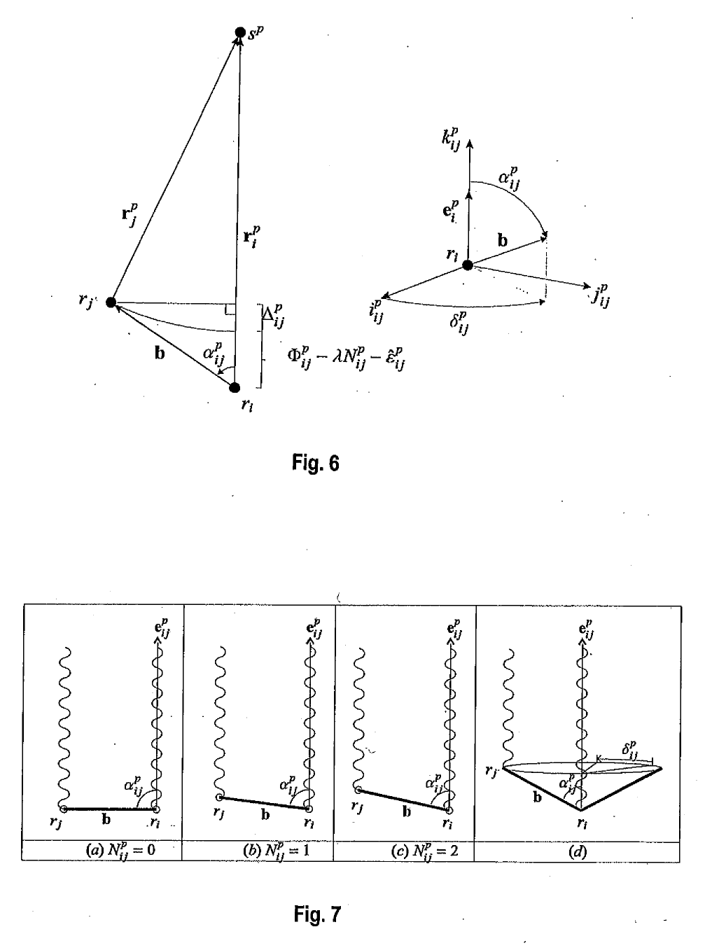

For the current explanation two receivers rᵢ and rⱼ are considered. The geometric interpretation for this set of receivers is given with reference to FIG. 6. For this situation the following relation applies:

Φ_{i j}^{p}−λN_{i j}^{p}−\hat{ε}_{i j}^{p}+Δ_{i j}^{p}=e_{i j}^{p}·b=∥e_{i j}^{p}∥ ∥b∥ cos(α_{i j}^{p}) 9

where

$$10 \text{:} {e}_{ij}^{p} = \frac{r \frac{p}{i}}{‖ r \frac{p}{i} ‖}$$

This general model reduces to the often used short baseline model wherein the baselines have a length ∥b∥<<∥rᵢ^{r}∥ for which it can be assumed that Δ≈0 (the error introduced when considering ∥b∥<100 m is <2.510⁻⁴ m which is sub-mm level):

Φ_{i j}^{p}−λN_{i j}^{p}−\hat{ε}_{i j}^{p}=e_{i j}^{p}·b=∥eᵢⱼ^{p}∥ ∥b∥ cos(α_{i j}^{p}) 11

In general the information which is available to solve the problem consists of the baseline length ∥b∥, the approximated value of

$$Δ \frac{p}{ij} ,$$

the normalized line of sight vectors

$$e \frac{p}{ij} ,$$

and the phase measurements

$$Φ \frac{p}{ij} .$$

There is uncertainty with respect to the correct integers

$$N \frac{p}{ij} ,$$

the value of the noise \hat{ε}_{i j}^{p}, and the orientation of the baseline b. The baseline can be written in terms of spherical coordinations (αᵢⱼ^{p},δᵢⱼ^{p},∥b∥) (see FIG. 6) where

$$α \frac{p}{ij}$$

is the angle between the baseline for receivers rᵢ and rⱼ and the normalized line of sight vector of satellite s^{p},
σᵢⱼ^{p} is the angle between the baseline for receivers rᵢ and rⱼ projected on the x−y plane of the local reference frame F^{p} and the x-axis of that reference frame.

As is shown in relation (9) and FIG. 7a-c, each integer corresponds to an angle

$$α \frac{p}{ij}$$

denoting the orientation of b with respect to the satellite line of sight vector

$$e \frac{p}{ij} .$$

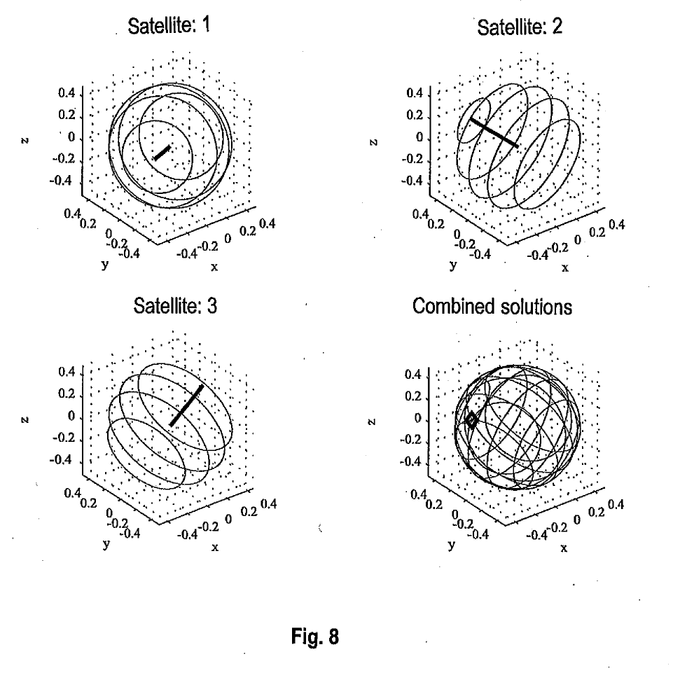

For each of those angles the single difference measurements will be the same. Obviously rotating the baseline around the line of sight vector with the angle σᵢⱼ^{p} (FIG. 7d), does not change the individual distances from the antennas to the satellite and thus the SD phase measurements are constant under this rotation. The possible orientations of the baseline based on a certain SD phase measurement, can therefore be described by a set of cone shells, where the tip of the cone is located in one antenna and the shell is formed by revolving the baseline around the line of sight vector to the satellite (see FIG. 8).

Obviously the same form of pattern of possible baseline orientations for each satellite exist although described in different local reference frames. The integer ambiguity problem can be solved by looking for points which lie within the set of possible orientations for all satellites, i.e. it concerns the points where the patterns of all satellites intersect (see FIG. 8, bottom right plot, common intersection point indicated by a diamond). When there is no noise on the phase measurements (\hat{ε}ᵢⱼ^{p}=0) there is at least one intersection point which therefore fulfills equation (9). The intersection point can be found by taking each possible combination of integers and see if the cone shells for the set of integers intersect at one point. The method of finding the possible baseline orientations is given in section II.C. First the double difference mode is briefly discussed.

II.B. Double difference model

The double difference model can be easily constructed from the single difference models by simple subtractions. The single difference model is given by:

Φ_{i j}^{p}−λN_{i j}^{p}−\hat{ε}_{i j}^{p}+Δ_{i j}^{p}=e_{i j}^{p}·b=∥e_{i j}^{p}∥ ∥b∥ cos(α_{i j} ^{p}) 13

where e_{i j}^{p} is the normalized unit vector for satellite p seen from receiver i. The double difference mode is simply the subtraction of two single difference models:

$$14 \text{:} ( Φ \frac{p}{ij} - Φ \frac{q}{ij} ) - ( λ N \frac{p}{ij} - λ N \frac{q}{ij} ) - ( \hat{ɛ} \frac{p}{ij} - \hat{ɛ} \frac{q}{ij} ) - ( Δ \frac{p}{ij} - Δ \frac{q}{ij} ) = e \frac{p}{ij} \cdot b - e \frac{q}{ij} \cdot b$$

This can be rewritten in the form

Φ_{i j}^{pq}−λN_{i j}^{pq}−\hat{ε}_{i j} ^{pq}+Δ_{i j}^{pq}=e_{i j}^{pq}·b 15

where

Φᵢⱼ^{pq}=Φᵢⱼ^{p}−Φᵢⱼ^{q}

Nᵢⱼ^{pq}=Nᵢⱼ^{p}−Nᵢⱼ^{q}

\hat{ε}ᵢⱼ^{pq}=\hat{ε}ᵢⱼ^{p}−\hat{ε}ᵢⱼ^{q}

Δᵢⱼ^{pq}=Δᵢⱼ^{p}−Δᵢⱼ^{q}

eᵢⱼ^{pq}=eᵢⱼ^{p}−eᵢⱼ^{q} 16

The first four terms are simple scalar subtractions while the last term is a vector subtraction. This means that the magnitude of eᵢⱼ^{pq} can vary from 0 to 2 depending on the orientations of the individual line of sight vectors. eᵢⱼ^{pq} is called the line of sight vector to the virtual satellite at position

$$r \frac{p}{i} - r \frac{q}{i} .$$

It is crucial that this vector is not normalized since the magnitude contains information of the underlying geometric representation. Double differencing leads to a reduction in the number of satellites since nₛₐₜ−1 virtual satellites can be created (one satellite is always taken as a reference).

As for the single difference model the geometric rule is defined:

Φ_{i j}^{pq}−λN_{i j}^{pq}−\hat{ε}_{i j}^{pq}=Δ_{i j}^{pq}=∥e_{i j}^{pq}∥ ∥b∥ cos(α_{i j}^{pq}) 17

for which it is assumed that the baseline lengths are small, i.e. Δᵢⱼ^{pq}≈0. The double difference case used virtual satellite positions, opposed to the single difference case of the previous section which uses real satellite positions. In the following section the method of finding the possible baseline orientations is discussed.

II.C. Finding possible baseline orientations

Finding all possible baseline orientations is a process of elimination. Every possible combination of integers must be evaluated. In order to determine whether a specific set of crisp integers N_{i j}=(N_{i j}¹, N_{i j}², . . . , N_{i j}ⁿ^{_{i sat}})^{t} with corresponding crisp phase measurements Φ_{i j}=(Φ_{i j}¹, Φ_{i j}¹, . . . ,Φᵢⱼⁿ^{ₛₐₜ})^{t} leads to a valid baseline orientation the geometric rules given in section II.A apply. In the following one specific set of receivers is regarded, hence the subscript ij is left out. Further, the theoretical framework of pᵢⱼ=0 is considered; i.e. no measurement errors are present. The process is as follows:

using the set of possible integer solutions N^{ρ}, corresponding phase measurements φ^{ρ}, approximated value of Δ^{ρ}, and the satellite line of sight vectors e^{ρ}, the corresponding cone angles α^{ρ}are determined.

by rotating the baseline about the line of sight vector e^{ρ}with angle σ^{ρ}a cone shell is obtained describing all possible baseline orientations (see section II.A). To determine the baseline orientation which is a solution for all satellites and phase measurements it suffices to compute the point where all cone shells intersect

if a common intersection point does not exist then the real baseline orientation is not described by the combination N,φ.

In order for the set N,φ to be a valid solution of the baseline orientation problem, there must be a point where all cone shells intersect. To check if such a point exists the values of σ^{pq} for every set of satellites e^{p}, e^{q} for q=1, 2, . . . , nₛₐₜ; q≠p are computed. It is not possible to directly compare these values of σ^{pq} because the reference frame F^{pq} is different per set e^{p}, e^{q}. Each value σ^{pq} has to be transformed to the correct value according to one global reference frame. To do so, one of the local reference frames F^{pq} is selected as a global one (F^{p}). Since the z-axis of each local F^{pq} reference frame is along e^{p} all x-axis are in the same plane. The transformation from the local reference frames to the global reference frame is just a single rotation about the z-axis of angle θ where θ is the angle between the global x-axis and the local x-axis:

φ^{pq}=α cos(î^{p}·î^{pq})

Note that the angle (Θ^{pq} must be defined in the correct direction (the correct direction is defined by the cross product î^{p}×î^{q} for which the resulting vector should point in the direction of e^{p}). If the angle computed using the previous relation is not in the correct direction then one should take 2ρ−Θ^{pq} as the angle. The point where all cone shells intersect is represented by:

$$( {α}^{p} , {δ}^{p} , ‖ b ‖ )$$

$$where$$

$${δ}^{p} = {{⋂}^{{n}_{slv}}}_{q = 1} ( {ϕ}^{pq} + {δ}^{pq} ) ;$$

$${δ}^{pp} = [ - π , π ]$$

If σ^{p} is empty than no solution exists and the combination N,φ is not a solution to the baseline orientation problem.

As stated in the beginning of this section one can find the correct baseline orientation in the theoretical framework of (\hat{ε}ᵢⱼ^{p}=0) by simply evaluating all possible integers. To find the solution in the presence of (measurement) errors, one needs to incorporate these errors in the intersection process. This encapsulation of errors is performed using intervals (FIG. 3). In order to resolve the integer ambiguity problem one needs to eliminate erroneous baseline orientation candidates. An efficient algorithm which evaluates all integer combinations within a specified search space is the Branch and Bound algorithm based on interval arithmetic as discussed below. This algorithm starts from [ N̅ ij]₀ containing the complete search space and converges efficiently to all possible baseline orientations, i.e. converges to interval vector set (|α_{i j}|,|δ_{i j}|,[∥b∥]) corresponding to a single crisp integer per satellite.

TABLE 1
Branch and Bound algorithm

0. Initialization: Determination of integer search space and filling Lstart = [αᵢⱼ]
OUTERLOOP
1. Initialize list L = Lₛₜₐᵣₜ

INNERLOOP

| | |
|---|---|
| a. | Take the interval vector [αᵢⱼ] from the list L |
| b. | Determine the interval cone intersection [δᵢⱼ] |
| c. | if [δ_{i ij} = Ø, proceed with the next interval vector in the list L else |

goto step (d).

| | |
|---|---|
| d. | If [α ᵢⱼ ] corresponds to a single integer per dimension then store |

(|αᵢⱼ|,|δᵢⱼ|) in L_{final}, else bisect [α ᵢⱼ ] and put it in the list L.

| | |
|---|---|
| e. | If L = Ø then break innerloop |

END INNERLOOP

2. If multiple solutions exist then use data from the next epoch with Lₛₜₐᵣₜ = L_{final},

else break outerloop

END OUTERLOOP

The algorithm is presented in table 1 and is set-up as follows:

Initialization

It is assumed that the algorithm is provided with the satellite line of sight vectors, or approximated receiver and satellite positions, phase measurements, baseline length and corresponding uncertainties in the form of intervals. From these quantities the integer search space for all satellites are defined. Using this search space the interval vector [αᵢⱼ] is determined.

Outer loop

Initially the baseline orientation is determined using one epoch. If multiple solutions remain then additional measurements must be used to eliminate the surplus of solutions (see section V.D below). When the inner loop is called for the first time the list Lₛₜₐᵣₜ contains the search space as determined in the initialization phase. For subsequent calls to the inner loop the list contains the search space spanned by the solutions provided by the previous call of the inner loop.

Inner loop

The inner loop determines the possible baseline orientations based on the provided data of a single epoch. The inner loop works as follows:
Pick the first interval vector [αᵢⱼ] from list L.
Determine interval cone intersection [δᵢⱼ]. If the intersection is empty then proceed with the next interval vector in the list (step 1), else go to step 3.
If the interval vector [αᵢⱼ] corresponds to a single integer per dimension then store the set (|α_{i j}|,|δ_{i j}|,[∥b∥]) as a possible solution for the baseline orientation, else bisect the interval vector (see section V.B below) and store the two resulting interval vectors [αᵢⱼ] in list L.

The inner loop is finished if list L is empty.

In the following three sections a number of important aspects of the algorithm are discussed.

V.A. Initialization

The initialization of the Branch and Bound algorithm consists of determining the total integer search space. This means the maximal range of integers for each satellite has to be determined. To do so, a distinction is made between two cases:

Short baseline

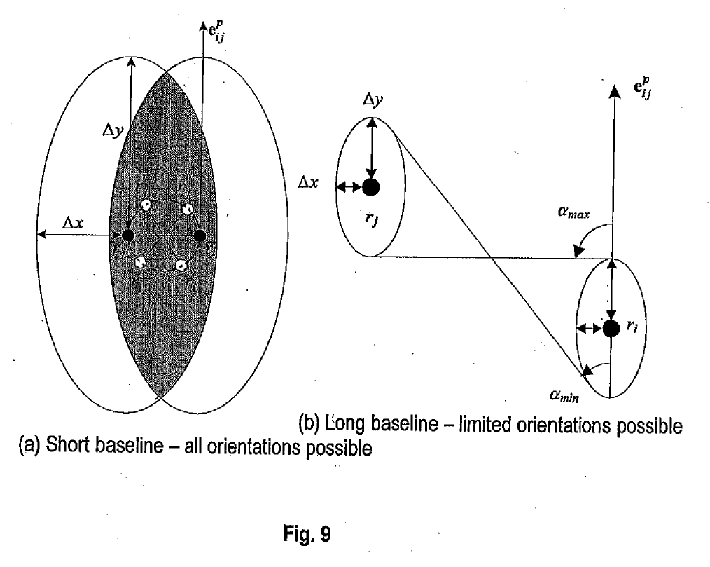

A baseline is considered short when the baseline length is smaller than the uncertainty in receiver positions. In that case no conclusion can be drawn about the orientation of the baseline since the positions of the receivers can lie anywhere in a volume with diameter larger than the baseline length (see FIG. 9a). This means that the whole search space (αᵢⱼ=[0,180]; δᵢⱼ=[0,360]) must be evaluated.

Long baseline

A baseline is considered long when the baseline length is larger than the uncertainty is receiver positions. In that case the possible orientation of the baseline is restricted (see FIG. 9b). This information can be used to reduce the integer search space and thus increase the efficiency of the algorithm.

Short baselines are considered only for which the range of possible integers per satellite is determined by the relation:

[φ_{i j}^{p}]−[N_{i j}^{p}]λ+Δ_{i j}^{p}=∥e_{i j}^{p}∥[∥b∥] cos([α_{i j}^{p}]) 18

Per definition αᵢⱼ^{p} lies in the interval [0, ρ] such that cos αᵢⱼ^{p} ε[−1, 1]. This means that the range of integers is determined by:

$$sup [ {N}_{ij}^{p} ] = floor \{ sup ( \frac{[ {φ}_{ij}^{p} ] + {Δ}_{ij}^{p} + ‖ {e}_{ij}^{p} ‖ [ ‖ b ‖ ]}{λ} ) \}$$

$$19 \text{:} inf [ {N}_{ij}^{p} ] = ceil \{ inf ( \frac{[ {φ}_{ij}^{p} ] + {Δ}_{ij}^{p} + ‖ {e}_{ij}^{p} ‖ [ ‖ b ‖ ]}{λ} ) \}$$

where floor means rounding downward to the nearest integer and cell means rounding upward to the nearest integer. Note that this definition of the maximum range of integers is also valid for the [symbol]
double difference model. Once the interval vector

[N_{i j}]=([N_{i j}¹],[N_{i j}²], . . . [N_{i j}^{p}])

has been determined again to determine the interval vector

$$[ {α}_{ij} ] = {( [ {α}_{ij}^{1} ] , [ {α}_{ij}^{2} ] , … [ {α}_{ij}^{P} ] )}^{t} \text{:} \\ 20 \text{:} [ {α}_{ij}^{p} ] = a cos ( \frac{[ {φ}_{ij}^{p} ] - [ {N}_{ij}^{p} ] λ + {Δ}_{ij}^{p}}{‖ {e}_{ij}^{p} ‖ [ ‖ b ‖ ]} ⋂ [ - 1 , 1 ] ) vp$$

The intersection with [−1,1] is taken because the term between the brackets can become larger than this interval while the acos function is only defined on the interval [−1,1].

V.B Bisections

Bisecting the interval vector [αᵢⱼ] is performed by first bisecting the corresponding integer interval vector [Nᵢⱼ] into [Nᵢⱼ]₁, [Nᵢⱼ]₂ using (22) and thereafter computing the interval vectors [αᵢⱼ]₁, [αᵢⱼ]₂ corresponding with the two integer interval sectors using (37).

A general interval vector [x] is bisected in the dimension which has the largest width. If dimension p has the largest width then the bisection yields two new interval vectors:

[x]₁=([x¹], [x²], . . . , [inf [x^{p}], mid [x^{p}]], . . . , [xⁿ])^{t}

[x]₂=([x¹], [x²], . . . , [mid [x^{p}], sup [x^{p}]], . . . , [xⁿ])^{t} 21

In the case of an integer interval vector the value of mid [Nᵢⱼ^{p}] can be a floating point or an integer. Since integer values are searched, it is possible to round up and down to the nearest integer in the case of a floating point value, while if the midpoint is an integer that integer must be put in only one of the new interval vectors to prevent double occurrence of integers. The bisection of the integer interval vector [Nᵢⱼ] thus becomes:

$$\{ \begin{matrix}\begin{matrix}{[ {N}_{ij} ]}_{1} = {( \begin{matrix}[ {N}_{ij}^{1} ] , [ {N}_{ij}^{1} ] , ... , \\ floor [ inf [ {N}_{ij}^{p} ] , mid [ {N}_{ij}^{p} ] ] , … , [ N \text{?} ]\end{matrix} )}^{t} \\ {[ {N}_{ij} ]}_{2} = {( \begin{matrix}[ {N}_{ij}^{1} ] , [ {N}_{ij}^{1} ] , ... , \\ ceil [ mid [ {N}_{ij}^{p} ] , sup [ {N}_{ij}^{p} ] ] , … , [ N \text{?} ]\end{matrix} )}^{t}\end{matrix} & \begin{matrix}if mid [ {N}_{ij}^{p} ] \neq \\ floor ( mid [ {N}_{ij}^{p} ] )\end{matrix} \\ \begin{matrix}{[ {N}_{ij} ]}_{1} = {( \begin{matrix}[ {N}_{ij}^{1} ] , [ {N}_{ij}^{1} ] , ... , \\ [ inf [ {N}_{ij}^{p} ] , mid [ {N}_{ij}^{p} ] ] , … , [ N \text{?} ]\end{matrix} )}^{t} \\ {[ {N}_{ij} ]}_{2} = {( \begin{matrix}[ {N}_{ij}^{1} ] , [ {N}_{ij}^{1} ] , ... , \\ [ mid [ {N}_{ij}^{p} ] , + 1 , sup [ {N}_{ij}^{p} ] ] , … , [ N \text{?} ]\end{matrix} )}^{t}\end{matrix} & \begin{matrix}if mid [ {N}_{ij}^{p} ] = \\ floor ( mid [ {N}_{ij}^{p} ] )\end{matrix}\end{matrix} \\ \text{?} \text{indicates text missing or illegible when filed} \qquad 22$$

The interval vectors [αᵢⱼ]₁, [αᵢⱼ]₂ corresponding with the two integer interval vectors [Nᵢⱼ]₁, [Nᵢⱼ]₂ can be computed using (9).

V.C Multiple frequencies

When GNSS satellites send out multiple frequencies and if the receivers are capable of processing these frequencies then the phase measurements of all frequencies can be used in the optimization algorithm. The relations given in the previous sections are valid for any frequency, i.e. any frequency with wavelength λ can be used. Relation (19) can be used to compute the correct initial integer interval for each specific wavelength λ. The process of computing the interval vector [αᵢⱼ] can also be performed for each frequency. Since the baseline orientation must be equal for every frequency the intersection of all interval vectors [αᵢⱼ]¹, [αᵢⱼ]² can be taken to obtain a possibly reduced interval vector which is used in the Branch and Bound algorithm:

$$[ {α}_{ij} ] = {{⋂}^{{n}_{freq}}}_{f = 1} {[ {α}_{ij} ]}^{{λ}_{f}} \qquad 23$$

where n_{freq} is the total of available frequencies and [α_{i j}]^{λf} is the interval vector computed using frequency f with corresponding wavelength λ_{f}. The computation of the interval cone intersections is performed using [αᵢⱼ] and can be seen as independent of frequency. The part where the frequencies are important again is the bisecting of [αᵢⱼ]. The bisection described in the previous section is for a single frequency. For multiple frequencies, the process of the previous section must simply be performed for each frequency. The interval vectors [αᵢⱼ]₁, [αᵢⱼ]₂ are then computed by taking the intersection of all interval vectors [α_{i j}]₁^{λf}, [α_{i j}]₂^{λf} according to (23).

V.D. Adding epochs

The addition of epochs is needed if the Branch and Bound algorithm has more than one solution from the inner loop which means that multiple baseline orientations are possible. To completely resolve the integer ambiguity the Branch and Bound inner loop is executed again with the data of the next measurement epoch but now with the solutions of the previous inner loop as starting point. Care must be taken to correct apply cycle-tracking, i.e. one may need to increase or decrease the integer with one. Cycle tracking is needed to guarantee that the integer vector for the second epoch corresponds to the integer vector of the first epoch and is crucial for finding a solution.

What is claimed is:

1. Transmitter-receiver system comprising at least three transmitters and at least a first receiver and a second receiver, wherein the receivers are connected to a computing device that is arranged to analyse signals that said receivers receive from said transmitters and to calculate length and attitude information of an imaginary baseline connecting said receivers depending on at least carrier phase information of said signals, wherein for each combination of transmitter i and receiver j the computing device establishes an imaginary interval cone having as an imaginary axis a line of sight between the combination's sender i and receiver j, and a top coinciding with the receiver j of such combination, said cone having a body with an interval-range for the top angle αij of said body defined by said imaginary baseline rotated around the line of sight between the transmitter i and receiver j, wherein the body of the cone represents an interval of integer values added to a phase value of the signal received by the receiver j of said combination, each integer value corresponding to a multiplication factor of the signal's wavelength, said phase value added to the interval of integer values thus corresponding to an interval of possible distances between said transmitter i and receiver j of such combination, and in that the computing device establishes for each two combinations of senders and receivers the respective top angles αij at which the corresponding interval cones intersect, and that upon such intersection the corresponding integer values are used as a measure for the orientation and length of said baseline between the receivers of both combinations.

2. Transmitter-receiver according to claim 1, wherein the selection of combinations of integers corresponding to intersecting imaginary interval cones is carried out by eliminating such intervals of integers which do not relate to intersecting interval cones.

3. Transmitter-receiver system according to claim 2, wherein the process of eliminating intervals of integers is carried out in steps wherein each step involves partitioning of the remaining intervals, and which process is completed when a single integer solution remains.

4. Method to calculate length and attitude information of an imaginary baseline connecting receivers of a transmitter-receiver system comprising at least three transmitters and at least a first receiver and a second receiver, wherein the receivers are connected to a computing device that is arranged to analyse signals that said receivers receive from said transmitters, wherein for each combination of transmitter i and receiver j an imaginary interval cone is established having as an imaginary axis a line of sight between the combination's sender i and receiver j, and a top coinciding with the receiver j of such combination, said cone having a body with an interval-range for the top angle αij of said body defined by said imaginary baseline rotated around the line of sight between the transmitter i and receiver j, wherein the body of the cone represents an interval of integer values added to a phase value of the signal received by the receiver j of said combination, each integer value corresponding to a multiplication factor of the signal's wavelength, said phase value added to the interval of integer values thus corresponding to an interval of possible distances between said transmitter i and receiver j of such combination, and in that for each two combinations of senders and receivers the respective top angles αij are established at which the corresponding interval cones intersect, and that upon such intersection the corresponding integer values are used as a measure for the orientation and length of said baseline between the receivers of both combinations.

5. Method according to claim 4, wherein the selection of combinations of integers corresponding to intersecting imaginary interval cones is carried out by eliminating such intervals of integers which do not relate to intersecting interval cones.

6. Method according to claim 5, wherein the process of eliminating intervals of integers is carried out in steps wherein each step involves partitioning of the remaining intervals, and which process is completed when a single integer solution remains.
